(19) United States
(12) Patent Application Publication
(10) Pub. No.: US 2026/0368613 A1
(43) Pub. Date: Nov. 19, 2026

(54) COMMUNICATION OF INFORMATION FOR OPTIMIZING DATA SAMPLES FOR MODEL TRAINING

(71) Applicant: Nokia Technologies Oy, Espoo (FI)

(72) Inventors: Borislava GAJIC, Unterhaching (DE); Shu Qiang SUN, Sichuan (CN); Stephen MWANJE, Dorfen (DE); Jing PING, Sichuan (CN)

(21) Appl. No.: 19/125,782

(22) PCT Filed: Nov. 4, 2022
(86) PCT No.: PCT/CN2022/130118

§ 371 Date: Apr. 30, 2025

(51) Int. Cl. G06N 20/00

(52) U.S. Cl. CPC G06N 20/00

(57) ABSTRACT

Embodiments of the present disclosure relate to devices, methods, apparatuses and computer readable storage media ML abstract behavior management. A method includes at a first device, receiving, from a second device, a first request used for querying effectiveness information of a plurality of data samples used for a model training at the first device; determining effectiveness information of at least one data sample of the plurality of data samples used for the model training, the effectiveness information indicating usefulness of at least one data sample or at least one data feature for a performance of the model training; and transmitting, to the second device, a first report indicating the effectiveness information.

### FIELDS

Various example embodiments of the present disclosure generally relate to the field of telecommunication and in particular, to methods, devices, apparatuses and computer readable storage medium for communicating information for optimizing data samples for model training.

### BACKGROUND

Basically, for an Artificial Intelligence (AI)/Machine Learning (ML) application workflow, the data sample collection is the original operation. The data sample quality and data sample quantity may have a significant impact to the execution of AI/ML model training, in terms of model training accuracy and training time.

Generally speaking, in order to train the ML model, the high quality and large amount of training data samples are mandatory. that is, in order to obtain a model with a high accuracy, the general practice is to collect as much data samples as possible, and then feed the collected data samples for pre-processing and model training. However, the time and resource costs for model training is increased thereby. Thus, there is a need to classify and optimize the data samples, such that the performance of model training may be improved accordingly.

### SUMMARY

In a first aspect of the present disclosure, there is provided a first device. The first device comprises at least one processor; and at least one memory storing instructions that, when executed by the at least one processor, cause the first device at least to perform: receiving, from a second device, a first request used for querying effectiveness information of a plurality of data samples used for a model training at the first device; determining effectiveness information of at least one data sample of the plurality of data samples used for the model training, the effectiveness information indicating usefulness of at least one data sample or at least one data feature for a performance of the model training; and transmitting, to the second device, a first report indicating the effectiveness information.

In a second aspect of the present disclosure, there is provided a second device. The second device comprises at least one processor; and at least one memory storing instructions that, when executed by the at least one processor, cause the second device at least to perform: transmitting, to a first device, a first request used for querying effectiveness information of a plurality of data samples used for a model training at the first device; and receiving, from the second device, a first report indicating effectiveness information of at least one data sample of a plurality of data samples used for the model training, the effectiveness information indicating usefulness of at least one data sample or at least one data feature for a performance of the model training, the effectiveness information being determined by the first device during performing the model training by using the plurality of data samples.

In a third aspect of the present disclosure, there is provided a first device. The first device comprises at least one processor; and at least one memory storing instructions that, when executed by the at least one processor, cause the first device at least to perform: receiving, from a second device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training; determining, the information based at least in part on the second request; and transmitting, to the second device, a second report indicating the information associated with the first plurality of data samples.

In a fourth aspect of the present disclosure, there is provided a second device. The second device comprises at least one processor; and at least one memory storing instructions that, when executed by the at least one processor, cause the second device at least to perform: transmitting, to a first device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training; and receiving, from the first device, a second report indicating the information associated with the first plurality of data samples.

In a fifth aspect of the present disclosure, there is provided a method. The method comprises: receiving, at a first device and from a second device, a first request used for querying effectiveness information of a plurality of data samples used for a model training at the first device; determining effectiveness information of at least one data sample of the plurality of data samples used for the model training, the effectiveness information indicating usefulness of at least one data sample or at least one data feature for a performance of the model training; and transmitting, to the second device, a first report indicating the effectiveness information.

In a sixth aspect of the present disclosure, there is provided a method. The method comprises: transmitting, at a second device and to a first device, a first request querying effectiveness information of a plurality of data samples used for a model training at the first device; and receiving, from the second device, a first report indicating effectiveness information of at least one data sample of a plurality of data samples used for the model training, the effectiveness information indicating usefulness of at least one data sample or at least one data feature for a performance of the model training, the effectiveness information being determined by the first device during performing the model training by using the plurality of data samples.

In a seventh aspect of the present disclosure, there is provided a method. The method comprises: receiving, at a first device and from a second device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training; determining, the information based at least in part on the second request; and transmitting, to the second device, a second report indicating the information associated with the first plurality of data samples.

In an eighth aspect of the present disclosure, there is provided a method. The method comprises: transmitting, at a second device and to a first device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training; and receiving, from the first device, a second report indicating the information associated with the first plurality of data samples.

In a ninth aspect of the present disclosure, there is provided a first apparatus. The first apparatus comprises means for receiving, from a second apparatus, a first request used for querying effectiveness information of a plurality of data samples used for a model training at the first apparatus; means for determining effectiveness information of at least one data sample of the plurality of data samples used for the model training, the effectiveness information indicating usefulness of at least one data sample or at least one data feature for a performance of the model training; and means for transmitting, to the second apparatus, a first report indicating the effectiveness information.

In a tenth aspect of the present disclosure, there is provided a second apparatus. The second apparatus comprises means for transmitting, to a first apparatus, a first request querying effectiveness information of a plurality of data samples used for a model training at the first apparatus; and means for receiving, from the second device, a first report indicating effectiveness information of at least one data sample of a plurality of data samples used for the model training, the effectiveness information indicating usefulness of at least one data sample or at least one data feature for a performance of the model training, the effectiveness information being determined by the first device during performing the model training by using the plurality of data samples.

In an eleventh aspect of the present disclosure, there is provided a first apparatus. The first apparatus comprises means for receiving, from a second apparatus, a second request for information associated with a first plurality of data samples used for a model training, a first plurality of effectiveness values of the first plurality of data samples being higher than a second plurality of effectiveness values of a second plurality of data samples used for the model training, the effectiveness information indicating usefulness of at least one data sample or at least one data feature for a performance of the model training; means for determining, the information based at least in part on the second request; and means for transmitting, to the second apparatus, a second report indicating the information associated with the first plurality of data sample.

In a twelfth aspect of the present disclosure, there is provided a second apparatus. The second apparatus comprises means for transmitting, to a first apparatus, a second request for information associated with a first plurality of data samples used for a model training, a first plurality of effectiveness values of the first plurality of data samples being higher than a second plurality of effectiveness values of a second plurality of data samples used for the model training, the effectiveness information indicating usefulness of at least one data sample or at least one data feature for a performance of the model training; and means for receiving, from the first apparatus, a second report indicating the information associated with the first plurality of data samples.

In a thirteenth aspect of the present disclosure, there is provided a computer readable medium. The computer readable medium comprises instructions stored thereon for causing an apparatus to perform at least the method according to the fifth aspect.

In a fourteenth aspect of the present disclosure, there is provided a computer readable medium. The computer readable medium comprises instructions stored thereon for causing an apparatus to perform at least the method according to the sixth aspect.

In a fifteenth aspect of the present disclosure, there is provided a computer readable medium. The computer readable medium comprises instructions stored thereon for causing an apparatus to perform at least the method according to the seventh aspect.

In a sixteenth aspect of the present disclosure, there is provided a computer readable medium. The computer readable medium comprises instructions stored thereon for causing an apparatus to perform at least the method according to the eighth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A to 1C illustrate example communication environments in which example embodiments of the present disclosure can be implemented;

FIGS. 2A and 2B illustrate example signaling diagrams of processes for optimizing data samples for model training according to some example embodiments of the present disclosure;

FIG. 3 illustrates another example signaling diagram of a process for optimizing data samples for model training according to some example embodiments of the present disclosure;

FIG. 4 illustrates a further example signaling diagram of a process for optimizing data samples for model training according to some example embodiments of the present disclosure;

FIG. 5 illustrates a further example signaling diagram of a process for optimizing data samples for model training according to some example embodiments of the present disclosure;

FIG. 6 illustrates a further example signaling diagram of a process for optimizing data samples for model training according to some example embodiments of the present disclosure;

FIG. 7 illustrates a flowchart of a method implemented at a first device according to some example embodiments of the present disclosure;

FIG. 8 illustrates a flowchart of a method implemented at a second device according to some example embodiments of the present disclosure;

FIG. 9 illustrates a flowchart of a method implemented at a first device according to some example embodiments of the present disclosure;

FIG. 10 illustrates a flowchart of a method implemented at a second device according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As briefly mentioned above, the data sample quality and data sample amount may have a significant impact to the execution of AI/ML model training, in terms of model training accuracy and training time.

Further, generally speaking, in order to train the ML model, the high quality and large amount of training data samples are mandatory. that is, in order to obtain a model with a high accuracy, the general practice is to collect as much data samples as possible, and then feed the collected data samples for pre-processing and model training. However, the model training is usually performed without considering the possibly different contributions of the different portions of input data samples to the accuracy of the trained model. As a result, the costs of both of the data collection and on computation resources are enormous, since even the data samples are unnecessary, the data samples still need be computed through the ML model.

In some example embodiments, the ML model training function may optimize the training data samples during model training, or before the training, e.g., by simply resampling the training data to only use part of the collected training data. However, such embodiments are not suitable for the mobile networks, because in the mobile networks, the amount of data samples is enormous, the resources are constrained, but accuracy of the model is strict. Without the insights of the effectiveness of the training data samples, the AI/ML model training has to be done with the full dataset, which will consume much more resources, like full data collection, data transmission or storage, data preparation for model training and so on. As a result, a significant increase of network load of data collecting at all network elements (including, radio nodes, core network functions, etc.), and transmission and extra time for training the ML model (with extra power consumption). Further, in case that the training data is collected from the terminal devices (i.e., UEs) or IoT devices, it would require more battery and computing power allocated for training redundant data collection. Another problem is that since all the data samples are treated equally important, which may impact the efficiency and accuracy of the model training process and result. This is particular useful for the regular model training/re-training use case.

In some example embodiments, it is proposed that the model may use only a portion of the available data sample based on some internal understanding of the data samples, such as, light gradient boosting machine (GMB). In one specific example embodiment, the number of the training data samples may be deceased using a feature of gradient-based one-side sampling (GOSS). As one specific example embodiment, it is noticed that the gradient for each data instance in gradient-boosting decision tree (GBDT) provides useful information for data sampling in that an instance associated with a small gradient has a small training error indicating that the sample is already well-trained.

Although it may be operationally possible to discard those data samples with small gradients. This, however, changes the data distribution and may hurt the accuracy of the learned model, and thus GOSS may be used to cure this deficiency. As a result, light GBM may be much faster than other gradient based boosting algorithm without negative impact to model performance. In view of this, the algorithms, such as light GBM may be used in wireless communication.

In a nutshell, by selecting of high-quality training data samples (which contribute more to the model training), the amount of training data samples may be reduced while the expected training accuracy may be achieved within a shorter training time, and further the data collection, data storage, data pre-procession also may be minimized, and thus the training efficiency is significantly improved. In view of this, there is a need to label the raining data samples with a tag, where the tag may indicate whether the data samples is useful or not useful for model training, or indicates the contribution value (such as, a weight between 0 and 1). Moreover, such tag information is expected to be known to the device that consumes the tag information. Specifically, in the wireless communication networks, it is expected to report contribution information of different training data samples based on insight of how the different portion of data contribute differently to the model accuracy.

Some example embodiments of the present disclosure provide a solution for optimizing the data samples. Specifically, the first device may determine effectiveness information of at least one data sample of the plurality of data samples during the model training, where the effectiveness information indicates usefulness of at least one data sample or at least one data feature for a performance of the model training. Further, the first device may transmit a first report indicating the effectiveness information to the second device. In this way, the second device.

consumes the effectiveness information may distinguish the data samples with higher contribution values to the other data samples.

Further, as discussed above, it is usually needed to collect data samples from all network elements and domains of the 5GS including 5G NR gNB, core network function, as well as data collection from terminals devices, or any other devices generating data for analytics. Thus, it would be expected that the unnecessary data sample collection may be avoided. In some example embodiments of the present disclosure, the effectiveness information may be obtained. However, the effectiveness information is inadequate to determine how to collect data samples and which data to collect in order to optimize the amount of data samples used for training and the related computation resources spent on model training.

Specifically, as discussed above, the effectiveness information may indicate information on such as whether a specific data sample is useful for the model training and on how much the data sample is useful for the mode training. Although such information can provide a valuable feedback to the management service (MnS) training consumer on how effective was the training data set in training procedure, even pinpointing the most valuable data samples of a given data set of already performed training, such “one-time”, simple categorization of data instances is rather insignificant for improving the future (re-)training procedures, if the available data is not further processed in order to gain more comprehensible insights.

In other words, a single/independent observation on whether a certain sample or feature at a given timestamp contributed to model gradients cannot provide understanding on whether using such a sample or feature will contribute to model accuracy of the same model in further training/re-trainings, or whether it will contribute to efficiency of training of further models related to the same use case. If the data sample collection procedure is performed without considering the effectiveness information, there will be significant increase of network load and energy consumption for data collection at all network elements, the AI/ML model training will be done on a dataset including unnecessary data consumes more resources (such as, computing, energy, and requires more time), and since all the data samples are treated equally important, the efficiency and accuracy of the model training process is reduced. Thus, the patterns of the most effective training data samples generated from the analytics would be very helpful to improve data sample collection in order to optimize the quantity and amount of the data sample to be used for model training.

In other words, further analysis of the data related to the importance of the data samples during training is needed.

Some example embodiments of the present disclosure provide a further solution for optimizing the data samples, Specifically, the first device may determine information associated with a first plurality of data samples used for a model training, where the first plurality of data samples may have higher effectiveness values. In this way, the data sample collection may be focused on the high-quality data samples.

In this way, the amount of data samples needed to be collected, transmitted, stored and pre-processed is decreased, and the model training performance is further increased thereby.

It is to be clarified that the specific wordings for data types/attributes are only for the purpose of illustration without suggesting any limitations. In some other example embodiments, the wordings for data types/attributes may be changed into any suitable wordings. The present disclosure is not limited in this regard.

Example embodiments of the present disclosure will be described in detail below with reference to the accompanying drawings.

### Example Environment and Work Principle

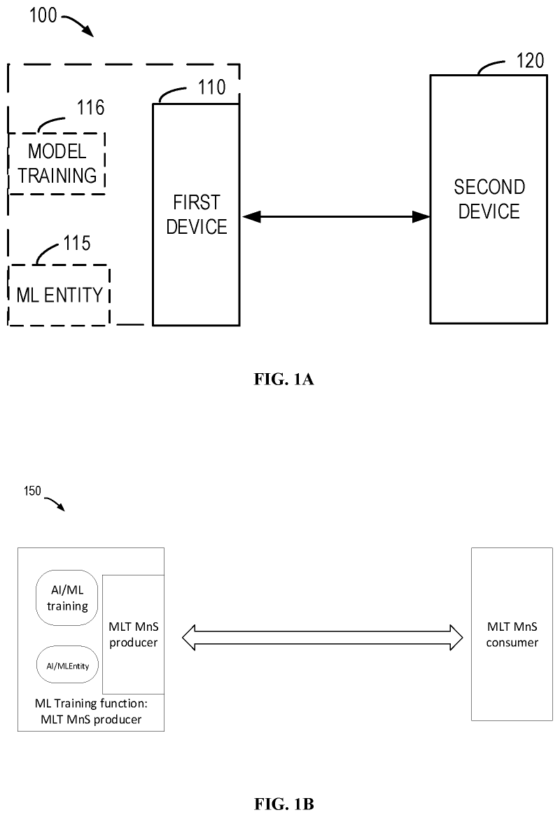

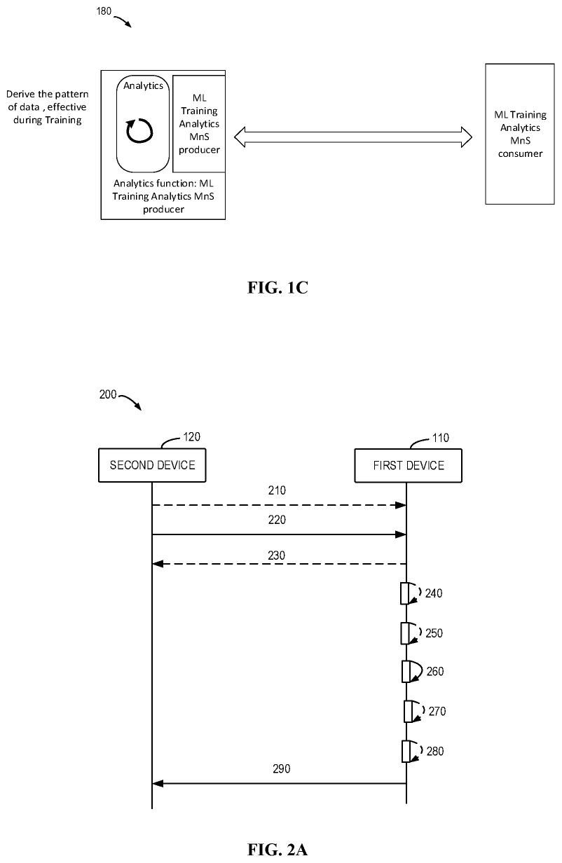

FIG. 1A illustrates an example communication environment 100 in which example embodiments of the present disclosure may be implemented. In the communication environment 100, there are a first device 110, a second device 120. Optionally, function of model training 116 and LM entity 115 also may be comprised in the communication environment 100.

In some example embodiments, the effectiveness information may be produced and consumed, as illustrated in FIG. 1B which illustrates an example communication environment 150. In this event, the second device 120 may be a management service (MnS) consumer/model training consumer, for example, an AI/ML MnS consumer, and the first device 110 may be a MnS producer, for example, an AI/ML MnS producer/model training producer.

In some example embodiments, the information associated with a first plurality of data samples of higher effectiveness values (refer to as analysis information for the purpose of discussion) may be produced and consumed. In this event, the first device 110 may be a MnS producer and the second device 120 may be a MnS consumer, the first device 110 is a producer for training data analytics and the second device 120 is a consumer for training data analytics, the first device 110 may be a management data analytics (MDA) producer and the second device 120 MDA consumer, or the first device 110 may be a AIMLT producer and the second device 120 AIMLT consumer.

It is to be understood that the above examples of the first device 110 and the second device 120 are only for the purpose of illustration without suggesting any limitations. In the present disclosure, as for the effectiveness information-related example embodiments, the first device 110 may be a device that provides the effectiveness information and the second device 120 may be a device that receives the effectiveness information. Further, as for the analysis information-related example embodiments, the first device 110 may be a device that provides the analysis information and the second device 120 may be a device that receives the analysis information. That is, the specific device type of the first device 110 and the second device 120 may be changed according to the specific application scenario and the specific network structure. The present disclosure is not limited in this regard.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example General Procedure for ML Abstract Behavior Management

In the following, for the purpose of illustration, some example embodiments are described with the first device 110 operating as a MnS producer, the second device 120 operating as a MnS consumer. However, in some other example embodiments, operations described in connection with the first device 110 may be implemented at a device other than the MnS consumer, and operations described in connection with the second device 120 may be implemented at a device other than the MnS producer.

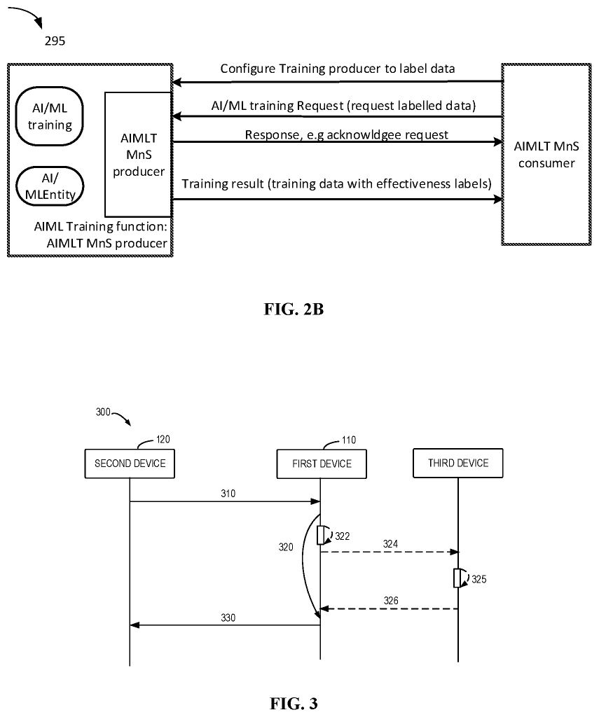

FIG. 2A illustrates an example signaling diagram of a process 200 for optimizing data samples for model training according to some example embodiments of the present disclosure.

In operation, the first device 110 receives 210 from a second device 120, a first request querying effectiveness information of a plurality of data samples used for a model training at the first device 110. The first device 110 determines 260 effectiveness information of at least one data sample of a plurality of data samples used for the model training, where the effectiveness information indicates usefulness of at least one data sample or at least one data feature for a performance of the model training. Then, the first device 110 transmits 290 a first report indicating the effectiveness information to the second device 120.

In some example embodiments, the function of transmitting the first report, the parameter(s) for obtaining effectiveness information and the parameter(s) for generating the first report may be configured, such as, by defining and configuring the data types and attribute parameters. Specifically, in some example embodiments, at least one parameter is configured to the first device 110. The at least one parameter comprises at least one of the following: a first indication used for enabling or disabling a function of transmitting the first report indicating the effectiveness information, or at least one attribute parameter for determining the effectiveness information.

In some example embodiments, the first device 110 receives 210 a configuration indicating the at least one parameter from a second device.

In some example embodiments, the effectiveness information is specific to at least one of the following: an inference type, a training data source, a data feature for the model training, or a data feature set for the model training.

In some example embodiments, the first report comprises at least one of the following: at least one respective effectiveness value of the at least one data sample, or storage information of the first report.

In some example embodiments, the first request used for querying effectiveness information of a plurality of data samples used for a model training at the first device may comprise a second indication that indicates the first device 110 to provide the effectiveness information.

In some example embodiments, the first report may comprise a third indication indicating one of the following: the effectiveness information requested by the second device 120 having been successfully determined; the effectiveness information requested by the second device 120 having been partially successfully determined; the effectiveness information requested by the second device 120 having not been determined; or not supporting to determine the effectiveness information requested by the second device.

In some example embodiments, the first device 110 is a producer for model training and the second device 120 is a consumer for model training.

In this way, a data-effectiveness-labelling process is proposed, where the process enables a training function to be configured to and to undertake the processes to identify and to provide reports on data samples that are useful to ML model training as well as the degree to which they are useful to the ML model training.

In some example embodiments, the ML model training function capable of data-effectiveness-labelling is enabled to generate information about how each training data instance or feature is contributing to the model training. Such information may be as part of training report or may be delivered is a special data-effectiveness report.

For better understanding, some specific example embodiments will still be discussed with reference to FIG. 2A. Further, the AI ML training consumer (AIMLT) is described as an example of the second device 120 and the AIMLT producer described as an example of the first device 110. It is to be understood that these specific device types may be changed into other device types. The present discourse is not limited in this regard.

In operation, the AIMLT consumer may optionally configure 210 the training data effectiveness feedback at the AIMLT producer to be enabled. In some example embodiments, the AIMLT consumer initiates the model training with training data effectiveness feedback enabled.

In some example embodiments, the AIMLT consumer requests 220 for model training. Optionally, the AIMLT consumer may transmit a first request 220 to the AIMLT producer.

In some example embodiments, the AIMLT producer sends 230 the response of model training request, to indicate the request is accepted but not yet completed. AIMLT Producer starts model training with full training data set.

In some example embodiments, the AIMLT producer prepares 240 the full training data sample set for model training.

In some example embodiments, the AIMLT producer starts 250 model training with full training data set.

In some example embodiments, the AIMLT producer collects 260 the results of effectiveness of each training data instance contribution to model training.

In some example embodiments, after AIML model training with raw data samples, the raw data samples may be separated into two parts:
One part of data instances is important for model training, called model training important data instances (MT-IDI).
The other part is contributing none or negligible to model accuracy, called as model training redundant data instances (MT-RDI).

In some example embodiments, the AIMLT producer labels 270 the raw full data samples as MT-RDI and MT-IDI.

In some example embodiments, the AIMLT producer optionally gets 270 the results of usefulness/importance of each data feature.

In some example embodiments, the AIMLT producer generates 280 the training data effectiveness report.

In some example embodiments, the AIMLT producer notifies 290 the AIMLT consumer with an AIML training report (such as, training data effectiveness report).

Still refer to FIG. 2A to discuss the workflow for report generation about training data contribution or effectiveness to model training.

In some example embodiments, the MT-RDI could be safely dropped from model training, as they are including no (or much less) additional information for model training accuracy.

In some example embodiments, the training producer mat produce the two data sets as MT-IDI, MT-RDI after the training. In the other words, label the whole training data samples as useful data samples or not useful data samples.

In some example embodiments, for the MT-IDI, the training producer may produce the importance information of data features. In some example embodiments, machine learning algorithms (e.g., random forest, different type of decision tree based model) may be used for generating the importance information of the data features.

Further, the information object class (IOC) needed to be integrated in the NRM for resulting the reporting as discussed below.

In some example embodiments, the AI/ML training capabilities are provided by an AIMLT MnS producer to one or more consumer(s).

In some example embodiments, the AI/ML training may be triggered by the request(s) from one or more AIMLT MnS consumer(s). To trigger an AI/ML training, the AIMLT MnS consumer requests the AIMLT MnS producer to train the AI/ML model or AI/ML enabled function. In the AI/ML training request, the consumer should specify the inference type which indicates the function or purpose of the AI/ML Entity, e.g., CoverageProblemAnalysis.

In some example embodiments, the AIMLT MnS producer can perform the training according to the designated inference type. The AIMLT MnS consumer may provide the data source(s) that contain(s) the training data which are considered as inputs candidates for training. To obtain the valid training outcomes, consumers may also designate their requirements for model performance (e.g., accuracy, etc) in the training request.

In some example embodiments, the AIMLT MnS producer provides a response to the consumer indicating whether the request was accepted.

In some example embodiments, the AIMLT MnS producer if the request is accepted, the AIMLT MnS producer decides when to start the AI/ML training with consideration of the request(s) from the consumer(s). Once the training is decided, the AIMLT producer may selects the training data, with consideration of the consumer provided candidate training data. Since the training data directly influences the algorithm and performance of the trained AI/ML Entity, the AIMLT MnS producer may examine the consumer's provided training data and decide to select none, some or all of them. In addition, the AIMLT MnS producer may select some other training data that are available. The AIMLT producer also trains the AI/ML Entity using the selected training data, and provides the training results (including the location of the trained AI/ML Entity, etc.) to the AIMLT MnS consumer(s).

In some example embodiments, the training report may include the effectiveness information for data in model training as per request from consumer.

In some example embodiments, a new attribute for providing feedback on effectiveness of training data to existing IOC AIMLTrainingRequest is added as below table 1. The new attribute may e.g. be called the trainingDataEffectivenessFeedback.

TABLE 1
examples of attribute

| | Support | | | | |
|---|---|---|---|---|---|
| Attribute name | Qualifier | isReadable | isWritable | isInvariant | isNotifyable |
| aIMLEntityId | M | T | T | F | T |
| candidateTraingDataSource | O | T | T | F | T |
| traingDataQualityScore | O | T | T | F | T |
| trainingRequestSource | M | T | T | F | T |
| requestStatus | M | T | T | F | T |
| expectedRuntimeContext | O | T | T | F | T |
| performanceRequirements | M | T | T | F | T |
| cancelRequest | O | T | T | F | T |
| suspendRequest | O | T | T | F | T |
| trainingDataEffectiveness- | O | T | T | F | T |
| Feedback | | | | | |

In some example embodiments, attribute of trainingDataEffectivenessFeedback will be a flag to allow consumer to request generate training data effective for mode training or not. It has the default value as FALSE, indicating consumer is not requesting training data effectiveness feedback. When the value has set to TRUE, AIMLT MnS Producer shall address the request related to training data effectiveness. In addition to explicitly request from consumer, the producer may decide to provide the trainingDataEffectivenessReport in training report.

In some example embodiments, a new datatype and some attributes are added to the IOC AIMLTrainingReport. Related descriptions are illustrated in below tables 2 and 3.

TABLE 2
examples of attribute

| | Support | | | | |
|---|---|---|---|---|---|
| Attribute name | Qualifier | isReadable | isWritable | isInvariant | isNotifyable |
| aIMLEntityId | M | T | F | F | T |
| areConsumerTrainingDataUsed | M | T | F | F | T |
| usedConsumerTrainingData | CM | T | F | F | T |
| confidenceIndication | O | T | F | F | T |
| modelPerformanceTraining | CM | T | F | F | T |
| areNewTrainingDataUsed | CO | T | F | F | T |
| trainingDataEffectivenessIndication | CM | T | F | F | T |
| trainingDataEffectivenessReport | CM | T | F | F | T |
| Attribute related to role | | | | | |
| trainingRequestRef | CM | T | F | F | T |
| trainingProcessRef | M | T | F | F | T |
| lastTrainingRef | CM | T | F | F | T |

TABLE 3
examples of attribute constraint

| Name | Definition |
|---|---|
| usedConsumerTrainingData Support | Condition: The value of areConsumerTraining- |
| Qualifier | DataUsed attribute is ALL or PARTIALLY. |
| trainingRequestRef Support Qualifier | Condition: The AIMLTrainingReport MOI represents |
| | the report for the AI/ML model training |
| | that was requested by the MnS consumer (via |
| | AIMLTrainingRequest MOI). |
| lastTrainingRef Support Qualifier | Condition: The AIMLTrainingReport MOI represents |
| | the report for the AI/ML model training |
| | that was not initial training (i.e., the model |
| | has been trained before). |
| modelPerformanceTraining Support | The condition is use case “AI/ML training |
| Qualifier | initiated by consumer” is supported. |
| areNewTrainingDataUsed Support | The condition is use case “AI/ML training |
| Qualifier | initiated by producer” is supported. |
| trainingDataEffectivenessIndication | The condition is use case “AI/ML training |
| Support Qualifier | data Effectiveness Report” is supported. |
| trainingDataEffectivenessReport | The condition is use case “AI/ML training |
| Support Qualifier | Effectiveness Report” is supported. |

In some example embodiments, attribute of trainingDataEffectivenessIndication will be a flag to indicate on or off of training data Effectiveness report.

In some example embodiments, the data type represents the report of training data for model training effectiveness. When the training data effectiveness report is enabled (by consumer or initiated by producer), at the end of model training, the report shall be included as part of MOI of AIMLTrainingReport.

In some example embodiments, the attribute of trainingDataEffectivenessFeedbackResult represents the overall status of report regarding training data instance effectiveness feedback request, it has the following values:
SUCCESSFUL_FEEDBACK indicates the training data effectiveness feedback request is successfully performed, and report is generated.
UNSUCCESSFUL_FEEDBACK indicates the training data effectiveness feedback request is not successfully performed, and report not generated.
PARTIAL_SUCCESSFUL_FEEDBACK indicates the training data effectiveness feedback request is partially successfully performed (e.g., feature effectiveness is done successfully, but not data instance effectiveness, or vice-vera, or only part of data instance effectiveness report done successfully), and report is generated.
NOTSUPPORT indicates the training data effectiveness feedback request is not supported.

In some example embodiments, the attribute of trainingDataInstanceEffectivenessInfo represents the overall effectiveness information of data used for model training.

In some example embodiments, the attribute of trainingDataSourceEffectivenessInfo represents the effectiveness information of data used for model training as per source of training data (e.g., producer provided, or consumer provided).

In some example embodiments, the attribute of trainingDataFeatureEffectivenessInfo represents the overall effectiveness information of training features for model training.

In some example embodiments, the attribute of trainingDataInstanceEffectivenessType represents the type of effectiveness is modelled, it is a list of enumerations:
BINARY_TYPE, indicates the training data instance is useful or not useful with only on and off,
WEIGHT_TYPE, indicates the contribution to measure by weights or real value from 0 to 1.0 indicates no contribution at all, the bigger value means the data instance contributing more to model training.

In some example embodiments, when the file retrieval NRM fragment is supported by the MnS producer, the attribute of “linkToReportFiles” attribute shall be supported.

Below tables 5 and 6 are further examples of attribute and attribute constraints.

TABLE 5
examples of attribute

| | Support | | | | |
|---|---|---|---|---|---|
| Attribute name | Qualifier | isReadable | isWritable | isInvariant | isNotifyable |
| trainingDataEffectivenessFeedbackResult | M | T | F | T | F |
| trainingDataInstanceEffectivenessInfo | CO | T | F | T | F |
| trainingDataSourceEffectivenessInfo | CO | T | F | T | F |
| trainingDataFeatureEffectivenessInfo | CO | T | F | T | F |
| trainingDataInstanceEffectivenessType | CO | T | F | T | F |
| linkToReportFiles | CO | T | F | T | F |

TABLE 5
examples of attribute constraint

| Name | Definition |
|---|---|
| trainingDataInstanceEffectivenessInfo | This attribute should be supported, when the value of trainingDataEffectivenessFeedbackResult |
| Support Qualifier | is SUCCESSFUL_FEEDBACK. |
| trainingDataSourceEffectivenessInfo | This attribute should be supported, when the value of trainingDataEffectivenessFeedbackResult |
| Support Qualifier | is SUCCESSFUL_FEEDBACK. |
| trainingDataFeatureEffectivenessInfo | This attribute should be supported, when the value of trainingDataEffectivenessFeedbackResult |
| Support Qualifier | is SUCCESSFUL_FEEDBACK and feature level contribution |
| | to model training is supported by MnS producer. |
| trainingDataInstanceEffectivenessType | This attribute should be supported, when the value of trainingDataEffectivenessFeedbackResult |
| Support Qualifier | is SUCCESSFUL_FEEDBACK. |
| _linkToReportFiles Support Qualifier | This attribute should be supported, when the MnS producer supports the file |
| | retrieval NRM fragment and report is generated successfully. |

In some example embodiments, training data effectiveness reporting (i.e., the first report) is introduced.

During AI/ML model training the training data effectiveness information can be provided on 1) whether a specific sample/data instance is useful for the training or not, and/or on how much such a sample/data instance is useful for the training; 2) whether a training feature (e.g, one measurement type among all types of KPI/measurements in input training data) of training data is useful for training or not, and/or how much the training feature is contributing to model training.

Whereas such information can provide a valuable feedback to the MnS training consumer on how effective was the training data set in training procedure, even pinpointing the most valuable data instances (and/or training feature) of a given data set of already performed training, such “one-time”, simple categorization of data instances is rather insignificant for improving the future (re-)training procedures, if the available data is not further processed in order to gain more comprehensible insights.

The example embodiments related to effectiveness information may be used to a use case of a plurality of use cases.

For AI/ML model training, a large amount of data instances does not necessarily add value, e.g., if only a portion contribute to actual model training, the other portion will be discarded by some well-designed algorithms, like LightGBM, which includes a GOSS feature. The feature will only use the top-N data instances with high gradient for model training and discard all the rest associated with small gradients, which has negligible or no contribution to model training. So LightGBM is much faster than other Gradient based boosting algorithms with no negative impact to model performance.

It is evident that such selection of high quality training data samples (which contribute more to model training), can reduce the volume of training data while could still enable the expected training accuracy with least training time as well as minimizing the data collection, data storage, data pre-procession, hence greatly improve the overall training efficiency.

Thus, it is necessary to provide means for AI/ML model training producer to report the effectiveness of data used in training, either on effectiveness of a specific sample/data instance, or effectiveness of a training feature (a specific input data, e.g, one measurement type among all types of KPI/measurements), or both. With insights in such report, the consumer and producer could take measures to optimize the model training, e.g., to ensure that minimizing storage and processing costs by discarding the less effective raw data does not compromise the ability to and still avails adequate historical information to adequately train AI/ML applications. In the other word, it is necessary for management system to generate effectiveness of data used in training, e.g., based on the actual contribution to model training.

In some example embodiments, the 3GPP management system shall have the capability to allow an authorized consumer to configure an AI/ML training function to report the effectiveness of data used for model training.

In some example embodiments, the 3GPP management system shall have the capability to report the effectiveness of data used in the training, including:
Indicate or label which data instance is useful or not useful;
Indicate which data feature is useful or not useful, or contributing negatively to the model training.

In some example embodiments, the 3GPP management system shall have the capability to allow the authorized consumer to activate the AI/ML training function/Entity to label the effectiveness of data used for training.

Further, for better understanding, reference may made to FIG. 2B, which illustrates an example signaling diagram of a process 295 for optimizing data samples for model training according to some example embodiments of the present disclosure.

The above processes are mainly discussed for the effectiveness information-related example embodiments. As discussed above, the effectiveness information may be used as an input parameter for determining information which may be used for optimizing the data sample collection, i.e., the information associated with a first plurality of data samples with higher effectiveness values.

Reference is made to FIG. 3 first, which illustrates an example signaling diagram of a process 300 for optimizing data samples for model training according to some example embodiments of the present disclosure. For the purposes of discussion, the procedure 300 will be discussed with reference to FIGS. 1A to 1C, for example, by using the first device 110 and the second device 120.

In operation, the first device 110 receives 310 a second request for information associated with a first plurality of data samples used for a model training, from a second device 120, where a first plurality of effectiveness values of the first plurality of data samples are higher than a second plurality of effectiveness values of a second plurality of data samples used for the model training, where the effectiveness value indicates a degree of usefulness of at least one data sample or at least one data feature for a performance of the model training.

The first device 110 determines 320 the information based at least in part on the second request, and then transmits 330 a second report indicating the information associated with the first plurality of data samples to the second device 120.

In some example embodiments, the first device 110 determines 322 the information by itself. Alternatively, the first device 110 determines 322 the information by requesting the information from a further device. Specifically, in some example embodiments, the first device 110 generates a third request for the information, based on the second request and transmit 324 the third request for the information to a third device which is a management data analytics (MDA) producer. Then, the first device 110 receives the information from the third device.

In some example embodiments, the second request comprises at least one parameter used for determining the first plurality of data samples, the at least one parameter comprising at least one of the following: an effectiveness threshold, version information of a model, or a specific use case of one or more model.

In some example embodiments, the first device 110 determines the information by determining the first plurality of data samples based on the at least one parameter, and determining the information based on context information of the first plurality of data samples.

In some example embodiments, the first device is a producer for model training and the second device is a consumer for model training.

Alternatively, in some example embodiments, the first device is a producer for management data analytics (MDA) and the second device is a consumer for MDA.

In some example embodiments, the information comprises at least one of the following: a combination of data features corresponding to the first plurality of data samples, identity information of at least one network object corresponding to the first plurality of data samples, geographical location information of the at least one network object, network area information corresponding to the first plurality of data samples, or collection time information corresponding to the first plurality of data samples.

It can be seen, during the process including actions of 324, 325 and 326, the operations of the first device 120 and the third device are similar with the operations of the second device 120 and the first device 110 with respect to a process including actions of 310, 320 and 330. Thus, the description of actions of 310, 320 and 330 may be applicable for actions 324, 325 and 326.

Reference is now made to FIG. 4, which illustrates an example signaling diagram of a process 400 for optimizing data samples for model training according to some example embodiments of the present disclosure. For the purposes of discussion, the procedure 400 will be discussed with reference to FIGS. 1A to 1C, for example, by using the first device 110 and the second device 120.

In operation, the second device 120 may transmit 410 a first request to the first device 110, where the first request may request the first device 110 to provide effectiveness information. The first device 110 may transmit 420 a response indicating that the first request is accepted. Then the first device 110 determines 430 the effectiveness information. Next, a first report indicating the effectiveness information may be provided to the second device 120.

Based on the first report, the second device 120 may transmit 450 a second request for information associated with a first plurality of data samples used for a model training to the third device. The third device may determine 460 the related information and transmitted this information to the second device 120. It can be seen, during the process including actions of 460 and 470, the operations of the second device 120 and the third device are similar with the operations of the second device 120 and the first device 110 with respect to a process including actions of 320 and 330. Thus, the description of actions of 320 and 330 may be applicable for actions 460 and 470.

According to some embodiments of the present discourse, a method used for analyzing the data in order to understand which data is the most useful for ML model training/re-training is introduced.

In some example embodiments, the outcome of such analysis may comprise insights on the combination of different data features, the data collected on certain network objects, the data collected in certain time period or any combination of thereof which contributed to the largest extend to the model training. Such insights are derived from information related to the importance/effectiveness of different training data samples or features from the output of an ML model training function capable of labelling its data samples and features with their effectiveness.

In some example embodiments, an attribute of effective training data pattern analytics consumer may request the producer to identify a pattern of the data used for training which contribute the most to the training process (e.g., input data that results in significant gradient changes).

In some example embodiments, the consumer may specify in his request if the most effective training data shall be derived for one of the following: a specific version of an ML model, all versions of an ML model, or all ML models related to a use case/problem.

In some example embodiments, the effective training data pattern analytics producer to derive and provide the pattern of the data used for training which contribute the most to the training process, i.e. effectiveTrainingDataPattern. Such pattern may comprise following information (or any combination of the following information):
set of data features which when used simultaneously (in combination) as input to model training have the significant effectiveness on the training process. This can be expressed by the list of e.g. DN (distinguished names) of performance metric or KPI that is the most significant for model training,
The list of DN (distinguished names) of the network objects from which the most effective data features have been collected,
The description of area from which the most effective data features have been collected, this can be expressed by e.g., list of cells (E-UTRAN-CGI or NG-RAN CGI), list of tracking area (identified by TAC-Tracking Area Code),
The info on geographical location of the network objects from which the most effective data features have been collected (latitude and longitude) or the larger geographical area information,
The time window(s) in which the most effective data features have been collected.

In some example embodiments, the effectiveTrainingDataPattern is derived by learning the associations between the data instance importance during ML model training and the context (e.g. time or geo-location) in which the given data instance has been collected.

In some example embodiments, such pattern can be used as a baseline for improving the collection of data to be used for model training. The EffectiveTrainingDataPatternAnalytics management service can be built-in to the MnS training producer. On the other hand, such capability could be part of MDAS producer in management domain, and NWDAF in core domain, or RAN intelligence in RAN domain.

In some example embodiments, the input to the analytics is a label indicating the importance of specific data samples or features (such as, effectiveness information), and similar to below 1 with highlighted column and row providing the outcome of the training data classification in terms of effectiveness (true/false) and effectiveness grade/weight (indicating to what extend the data instance or individual feature contributes to gradients). Such classification provides the effectiveness/importance labels of data instances used during training of AI/MLEntity with a given aIMLEntity ID (optionally along with all mLEntity Versions trained in past) or all AIMLEntities of a given inference Type. Effectiveness/importance labels provide the info on how useful particular data instance was in AI/MLEntity training.

TABLE 7
Example labelling of the effectiveness of individual sample for data training

| ID | Timestamp | Cell_name | ERAB_F [symbol] _Resource | Avg_Lat_All_5QI | DL_PR [symbol] _Percent | Effectiveness/gra [symbol] |
|---|---|---|---|---|---|---|
| 1 | 2019-04-19T15:00:00Z | CELL90FDD3 | 0 | 16 | 8.1 | T/0.8 |
| 2 | 2019-04-19T15:15:00Z | CELL90FDD3 | 0 | 9 | 5.4 | T/0.9 |
| 3 | 2019-04-19T15:30:00Z | CELL90FDD3 | 0 | 16 | 9.2 | T/0.7 |
| 4 | 2019-04-19T15:45:00Z | CELL90FDD3 | 0 | 9 | 8.5 | T/0.8 |
| 5 | 2019-04-19T16:00:00Z | CELL90FDD3 | 0 | 7 | 10 | T/0.66 |
| 6 | 2019-04-19T16:15:00Z | CELL90FDD3 | 0 | 20 | 15.9 | T/0.77 |
| 7 | 2019-04-19T16:30:00Z | CELL90FDD3 | 0 | 23 | 8.1 | T/0.69 |
| 8 | 2019-04-19T16:45:00Z | CELL90FDD3 | 0 | 39 | 10.9 | T/0.86 |
| 9 | 2019-04-19T15:00:00Z | CELL92FDD4 | 0 | 106 | 53.3 | F/0.0001 |
| 10 | 2019-04-19T15:15:00Z | CELL92FDD4 | 0 | 77 | 46.5 | F/0.002 |
| 11 | 2019-04-19T15:30:00Z | CELL92FDD4 | 0 | 75 | 63.9 | F/0.003 |
| 12 | 2019-04-19T15:45:00Z | CELL92FDD4 | 0 | 86 | 52.2 | F/0.005 |
| 13 | 2019-04-19T16:00:00Z | CELL92FDD4 | 0 | 92 | 57.4 | F/0.01 |
| 14 | 2019-04-19T16:15:00Z | CELL92FDD4 | 0 | 150 | 92.1 | F/0.009 |
| 15 | 2019-04-19T16:30:00Z | CELL92FDD4 | 0 | 149 | 81.6 | F/0.0034 |
| 16 | 2019-04-19T16:45:00Z | CELL92FDD4 | 0 | 66 | 38.4 | F/0.005 |
| n/a | Effectiveness/ | T/0.8 | F/0.0001 | T/0.61 | T/0.8 | n/a |
| | grade | | | | | |

[symbol]

indicates data missing or illegible when filed

In the above table 7, the first row is the header of data and each column is called a data feature; each row, except the header row, is called a data instance or data sample. The Header row and ID column are not used in model training. The ID is used to unique identify a data instance if there is no other unique key to identify a data instance.

In example embodiments, the output of the analysis is the effective TrainingDataPattern which can be expressed as a generic effectiveTrainingDataPattern (i.e., a data type) (e.g., used as output from MDA producer) with following attributes, each of which as a separate datatype:
effectiveDataFeatures: combination of the data features with the most effect on the ML training,
effectiveNetworkObjects: list of network objects from which the effective data has been collected,
effectiveLocation: description of geographical location or area from which the effective data has been collected,
effectiveTime: time instance or period in which the effective data has been collected,
effectiveDataHybrid: any combination of the attribute datatypes above (e.g., effectiveNetworkObjects and effective Time indicating network objects and time from which the effective data has been collected).

In some example embodiments, such pattern of most effective training may represent a property of an AIML entity, therefore for each AIML entity a corresponding description of pattern for most effective training data may be part of the AIML entity. Below Tables 8 and 9 illustrates examples of the newly-defined attribute and attribute constraints.

TABLE 8
Example of attribute

| | Support | | | | |
|---|---|---|---|---|---|
| Attribute name | Qualifier | isReadable | isWritable | isinvariant | isNotifyable |
| mLEntityId | M | T | F | F | T |
| inferenceType | M | T | F | F | T |
| mLEntityVersion | M | T | F | F | T |
| expectedRunTimeContext | O | T | T | F | T |
| trainingContext | CM configuration | T | F | F | T |
| | management | | | | |
| | (CM) values | | | | |
| runTimeContext | O | T | F | F | T |
| effectiveTrainingDataPattern | CM | T | F | F | T |

TABLE 9
Example of attribute constraints.

| Name | Definition |
|---|---|
| effectiveTrainingDataPattern | Condition: The effectiveTrainingDataPattern represents the |
| Support Qualifier | property of an ML entity and should be added when this information is |
| | requested. |

In some example embodiments, the effectiveTrainingDataPattern can be derived and associated to specific tuple of mLEntityId, inferenceType and mLEntity Version. However, the effectiveTrainingDataPattern can be derived for certain mLEntityId which is valid for all versions of that AIMLEntity. Furthermore, the MnS Producer may derive the effectiveTrainingDataPattern for certain inference type which should give a good indication on which data is the most effective to be used for training of ML models related to some specific use case indicated via inference type.

An example of end-to-end flow are described as below. In some example embodiments, the MnS Consumer (e.g., an operator) may be interested in gaining the insights on which data, e.g., combination of with features collected on which network objects and when, are contributing to the largest extend in effectiveness of the training process. The MnS Consumer may issue a new request proposed in this invention AI/ML training analytics request by specifying the at least one of the following inputs:

aIMLEntity ID (optionally along with mLEntity Version) or inferenceType.

Optionally, the MnS Consumer may indicate the thresholds, above which the data instance is considered to be effective in model training, and based on which the consumer requests the analytics. It is be noted that in this step we describe the generic request for performing analytics on training data, however, such request can be an extension of training request. Furthermore, as indicated above the capability of performing analytics on training data effectiveness can be built-in to MnS training producer, MDAS producer in management domain, and NWDAF in core domain, or RAN intelligence in RAN domain. Section 6.4 provides more details on these different options.

In some example embodiments, the MnS producer relies on the labelling of the training data. The MnS producer takes into account only the most significant data during MLEntity training and analyses its context data, e.g., in terms of network objects and/or geo-location from which particular data instance is collected, the time instance in which particular data instance is collected, and so on.

In the case that MnS consumer provided the specific thresholds based on which the data shall be considered effective or not, the MnS producer will use this as a baseline in performing the requested analytics. Namely, the MnS Producer may consider only the data samples above the desired effectiveness thresholds, analyze which features contribute the most, especially for which combination of different features the most significant impact to gradients has been observed. Once the most significant combination of data features is identified the MnS Producer may identify for such specific feature combination at what time instances the input data samples were mostly impactful. Out of such individual time instances, the most impactful time periods can be derived, e.g., rush hours (7 am-9 am and 4 pm-6 pm) of working days.

Similarly, the MnS producer can identify individual network object from which such most impactful data instances were collected. By further analysis and aggregation of such individual network objects the MnS Producer may identify the geographical areas from which the most impactful data instances have been collected, e.g., urban areas.

In some example embodiments, the MnS Producer provides the analytics result to MnS Consumer containing the description of the pattern that the most significant data instances have. The pattern description can contain following attributes:
Combination of data features with the most effect to training, this can be expressed by e.g., DN (distinguished names) of performance metric or KPI that is the most significant for model training. E.g., from table 7: combination of Avg_Lat_All_5QI and DL PRB_Util_Percent may be indicated.
DN (distinguished names) of the objects on which the data has been selected collected. E.g., from table 7: CELL90FDD3.
The area description from which the most effective data has been collected, this can be expressed by e.g., list of cells (E-UTRAN-CGI or NG-RAN CGI), list of tracking area (identified by TAC-Tracking Area Code).
The info on geographical location of the object from which the most effective data has been collected (latitude and longitude) or the larger geographical area information,
The time window(s) in which the most effective data has been collected. E.g., from table 7 2019-04-19T15:00 until 16:00, or
Any combination of the attributes above.

In some example embodiments, such pattern can be provided for specific version of AIML entity, for all version of AIML entity, or for all AIML entities related to certain use case/problem, e.g., “coverage and capacity optimization”.

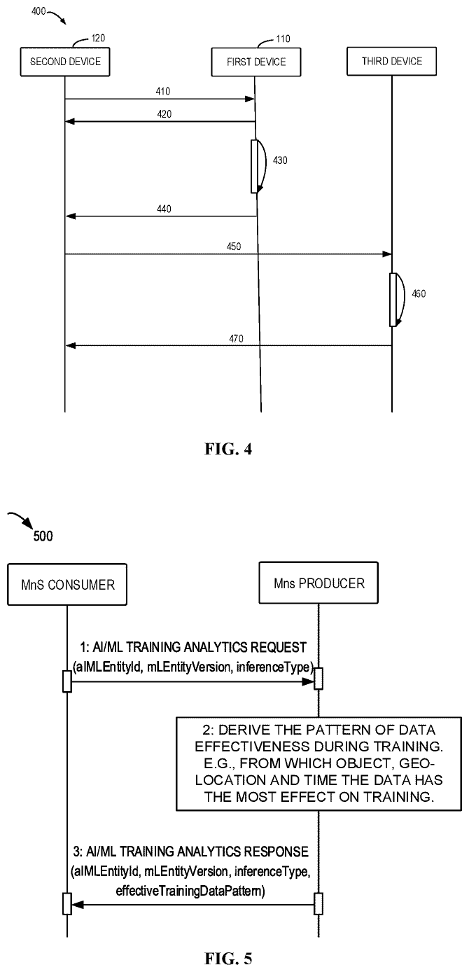

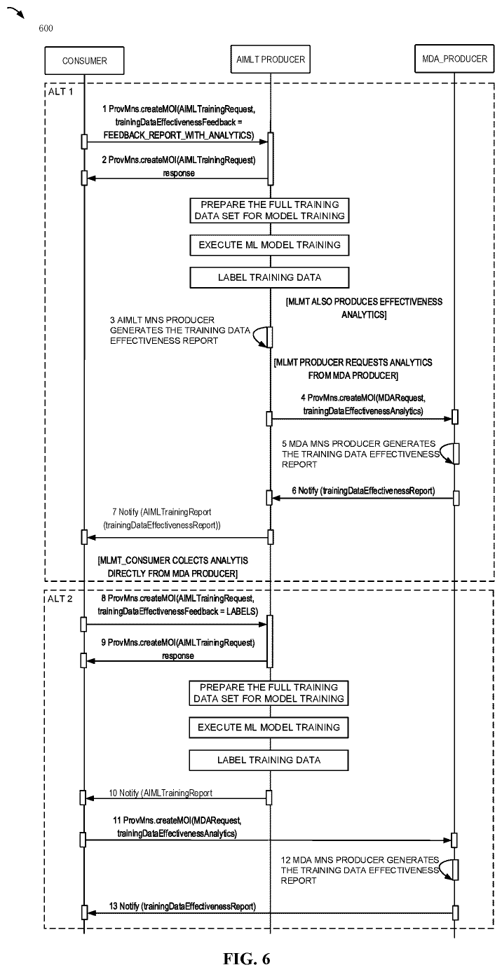

FIGS. 5 and 6 illustrate examples signaling diagram of a process 500 and 600 for optimizing data samples for model training according to some example embodiments of the present disclosure.

In some example embodiments, the capability of performing analytics on training data effectiveness can be built-in to MnS Training Producer, MDA service (MDAS) producer in management domain, and network data analytics function (NWDAF) in core domain, or RAN intelligence in RAN domain. FIG. 6 illustrates the options where such capability is part of MnS Training Producer and MDAS producer (MDA_producer in FIG. 6). The request to perform the analytics on training data effectiveness is extension of AIML Training request.

In the specific embodiment of FIG. 6, the capability of requesting the analytics on training data effectiveness is either part of AIMLT Producer or MDA_producer.

In some example embodiments, the consumer initiates the model training with enabled training data effectiveness feedback including the analytics. The producer sends the response of model training request, to indicate the request is accepted but not yet completed. If the analytics capability is available at AIMLT Producer, it performs the analytics on effectiveness of data used for model training (step 2). Otherwise, the AIMLT Producer can request MDA_Producer to perform such analytics. The MDA_Producer generates the analytics as requested by the AIMLT Producer. MDA_Producer notifies the AIMLT Producer on derived analytics on training data effectiveness. Finally, the consumer is notified about requested analytics on training data effectiveness.

Alternatively, in some other example embodiments, the consumer may request training data effectiveness directly from MDA_Producer. Action 10 is an interaction between Consumer and AIMLT Producer in order to perform the training and provide the labels indicating the training data effectiveness. The consumer requests the effectiveness analytics from MDA_Producer on effectiveness of data used for model training. The MDA_Producer generates effectiveness report by performing analytics. Then, the MDA_Producer notifies the Consumer on derived analytics on training data effectiveness.

In some example embodiments, during ML model training the information can be provided on whether a specific sample is useful for the training or not and on how much such a sample is useful for the training. Whereas such information can provide valuable feedback to the MnS training consumer on how effective the training data set is in training procedure, even pinpointing the most valuable data instances of a given data set of already performed training, such “one-time”, simple categorization of data instances is rather insignificant for improving the future (re-)training procedures, if the available data is not further processed in order to gain more comprehensible insights.

In some example embodiments, a single/independent observation on whether a certain sample or feature at a given timestamp contributed to model gradients cannot provide understanding on whether using such a sample or feature will contribute to model accuracy of the same model in further training/re-trainings, or if it will contribute to efficiency of training of further models related to the same use case.

In order to have such understanding, further analysis of the data related to the importance of the data instances during training is needed. The patterns of the most effective training data generated from the analytics would be very helpful to improve data collection in order to optimize the quantity and quality of the data to be used for training.

In some example embodiments, the 3GPP management system shall have the capability to allow authorized consumer to request analytics for data used for model training with respect to effectiveness of such data during model training.

In some example embodiments, the 3GPP management system shall have the capability to generate and to provide to consumer a pattern of highly effective data for training of either specific version of a model, all versions of a single model, or all models related to certain use case.

### Example Methods

FIG. 7 shows a flowchart of an example method 700 implemented at a first device in accordance with some example embodiments of the present disclosure. For the purpose of discussion, the method 700 will be described from the perspective of the first device 110 in FIG. 1A.

At block 710, the first device receives, from a second device, a first request querying effectiveness information of a plurality of data samples used for a model training at the first device.

At block 720, the first device determines, effectiveness information of at least one data sample of a plurality of data samples used for the model training, the effectiveness information indicating usefulness of at least one data sample or at least one data feature for a performance of the model training.

At block 730, the first device transmits, to the second device, a first report indicating the effectiveness information.

In some example embodiments, the method further comprises: configuring, at least one parameter to the first device, the at least one parameter comprising at least one of the following: a first indication used for enabling or disabling a function of transmitting the first report indicating the effectiveness information, or at least one attribute parameter for determining the effectiveness information.

In some example embodiments, the method further comprises: receiving, from a second device, a configuration indicating the at least one parameter.

In some example embodiments, the effectiveness information is specific to at least one of the following: an inference type, a training data source, a data feature for the model training, or a data feature set for the model training.

In some example embodiments, the model training at the first device is triggered by a receipt of the first request.

In some example embodiments, the first request used for triggering the model training comprises a second indication that indicates the first device to provide the effectiveness information.

In some example embodiments, the first report comprises a third indication indicating one of the following: the effectiveness information requested by the second device having been successfully determined; the effectiveness information requested by the second device having been partially successfully determined; the effectiveness information requested by the second device having not been determined; or not supporting to determine the effectiveness information requested by the second device.

In some example embodiments, the first device is a producer for model training and the second device is a consumer for model training.

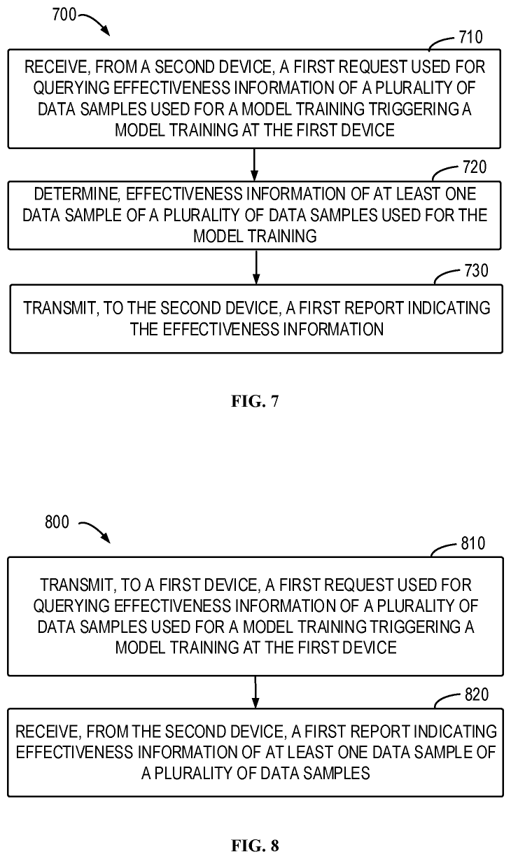

FIG. 8 shows a flowchart of an example method 800 implemented at a second device in accordance with some example embodiments of the present disclosure. For the purpose of discussion, the method 800 will be described from the perspective of the second device 120 in FIG. 1A.

At block 810, the second device transmits, to a first device, a first request used for querying effectiveness information of a plurality of data samples used for a model training at the first device at the first device.

At block 820, the second device receives, from the second device, a first report indicating effectiveness information of at least one data sample of a plurality of data samples used for the model training, the effectiveness information indicating usefulness of at least one data sample or at least one data feature for a performance of the model training, the effectiveness information being determined by the first device during performing the model training by using the plurality of data samples.

In some example embodiments, the method further comprises: transmitting, a configuration indicating the at least one parameter comprising at least one of the following: a first indication used for enabling or disabling a function of transmitting the first report indicating the effectiveness information, or at least one attribute parameter for determining the effectiveness information.

In some example embodiments, the first report comprises at least one of the following: effectiveness values of the respective at least one data sample, or storage information of the first report.

In some example embodiments, the effectiveness information is specific to at least one of the following: an inference type, a training data source, a data feature for the model training, or a data feature set for the model training.

In some example embodiments, the model training at the first device is triggered by a receipt of the first request.

In some example embodiments, the first report comprises a third indication indicating one of the following: the effectiveness information requested by the second device having been successfully determined, the effectiveness information requested by the second device having been partially successfully determined, the effectiveness information requested by the second device having not been determined, or not supporting to determine the effectiveness information requested by the second device.

In some example embodiments, the method further comprises: configuring the second device to enable the second device to transmit the first request comprising second indication.

In some example embodiments, the first device is a producer for model training and the second device is a consumer for model training.

FIG. 9 shows a flowchart of an example method 900 implemented at a third device in accordance with some example embodiments of the present disclosure. For the purpose of discussion, the method 900 will be described from the perspective of the first device 1a0 in FIG. 1A.

At block 910, the first device receives, from a second device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training.

At block 920, the first device determines, the information based at least in part on the second request.

At block 930, the first device transmits, to the second device, a second report indicating the information associated with the first plurality of data samples.

In some example embodiments, determining the information comprises:
generating, based on the second request, a third request for the information; transmitting, the third request for the information to a third device which is a management data analytics (MDA) producer; and receiving the information from the third device.

In some example embodiments, the second request comprises at least one parameter used for determining the first plurality of data samples, the at least one parameter comprising at least one of the following: an effectiveness threshold, version information of a model, or a specific use case of one or more model.

In some example embodiments, determining the information comprises:
determining the first plurality of data samples based on the at least one parameter, and determining the information based on context information of the first plurality of data samples.

In some example embodiments, the information comprises at least one of the following: a combination of data features corresponding to the first plurality of data samples, identity information of at least one network object corresponding to the first plurality of data samples, geographical location information of the at least one network object, network area information corresponding to the first plurality of data samples, or collection time information corresponding to the first plurality of data samples.

In some example embodiments, the first device is a producer for model training and the second device is a consumer for model training, the first device is a producer for training data analytics and the second device is a consumer for training data analytics, or the first device is a producer for management data analytics (MDA) and the second device is a consumer for MDA.

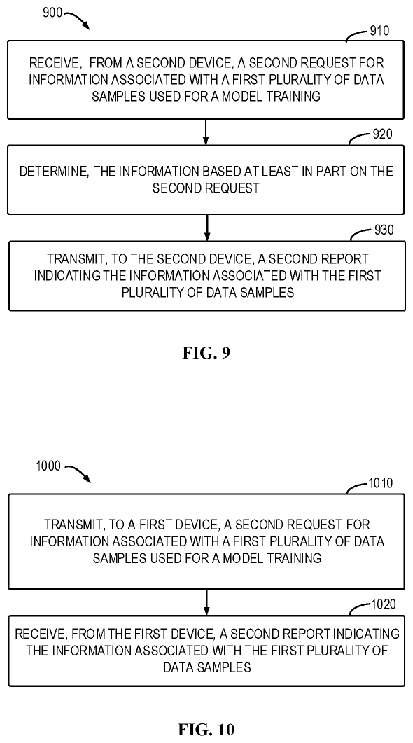

FIG. 10 shows a flowchart of an example method 1000 implemented at a fourth device in accordance with some example embodiments of the present disclosure. For the purpose of discussion, the method 1000 will be described from the perspective of the second device 120 in FIG. 1.

At block 1010, the first device transmits, to a first device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training.

At block 1020, the first device receives, from the first device, a second report indicating the information associated with the first plurality of data samples.

In some example embodiments, the second request comprises at least one parameter used for determining the first plurality of data samples, the at least one parameter comprising at least one of the following: an effectiveness threshold, version information of one or more model, or a specific use case of one or more model.

In some example embodiments, the information comprises at least one of the following: a combination of data features corresponding to the first plurality of data samples, identity information of at least one network object corresponding to the first plurality of data samples, geographical location information of the at least one network object, network area information corresponding to the first plurality of data samples, or collection time information corresponding to the first plurality of data samples.

In some example embodiments, the first device is a producer for model training and the second device is a consumer for model training, the first device is a producer for training data analytics and the second device is a consumer for training data analytics, or the first device is a producer for management data analytics (MDA) and the second device is a consumer for MDA.

### Example Apparatus, Device and Medium

In some example embodiments, a first apparatus capable of performing any of the method 700 (for example, the first device 110 in FIG. 1A may comprise means for performing the respective operations of the method 700. The means may be implemented in any suitable form. For example, the means may be implemented in a circuitry or software module. The first apparatus may be implemented as or included in the first device 110 in FIG. 1A.

In some example embodiments, the first apparatus comprises means for receiving, from a second apparatus, a first request used for querying effectiveness information of a plurality of data samples used for a model training at the first apparatus; means for determining effectiveness information of at least one data sample of the plurality of data samples used for the model training, the effectiveness information indicating usefulness of at least one data sample or at least one data feature for a performance of the model training; and means for transmitting, to the second apparatus, a first report indicating the effectiveness information.

In some example embodiments, further comprising: means for configuring, at least one parameter to the first apparatus, the at least one parameter comprising at least one of the following: a first indication used for enabling or disabling a function of transmitting the first report indicating the effectiveness information, or at least one attribute parameter for determining the effectiveness information.

In some example embodiments, further comprising: means for receiving, from a second apparatus, a configuration indicating the at least one parameter.

In some example embodiments, the effectiveness information is specific to at least one of the following: an inference type, a training data source, a data feature for the model training, or a data feature set for the model training.

In some example embodiments, the first report comprises at least one of the following: at least one respective effectiveness value of the at least one data sample, or storage information of the first report.

In some example embodiments, the model training at the first device is triggered by a receipt of the first request.

In some example embodiments, the first report comprises a third indication indicating one of the following: the effectiveness information requested by the second apparatus having been successfully determined; the effectiveness information requested by the second apparatus having been partially successfully determined; the effectiveness information requested by the second apparatus having not been determined; or not supporting to determine the effectiveness information requested by the second apparatus. In some example embodiments, the first apparatus is a producer for model training and the second apparatus is a consumer for model training.

In some example embodiments, the first apparatus further comprises means for performing other operations in some example embodiments of the method 700 or the first device 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the second device 120 in FIG. 1A may comprise means for performing the respective operations of the method 800. The means may be implemented in any suitable form. For example, the means may be implemented in a circuitry or software module. The second apparatus may be implemented as or included in the second device 120 in FIG. 1A.

In some example embodiments, the second apparatus comprises means for transmitting, to a first apparatus, a first request used for triggering a model training at the first apparatus; and means for receiving, from the second apparatus, a first report indicating effectiveness information of at least one data sample of a plurality of data samples used for the model training, the effectiveness information indicating usefulness of at least one data sample or at least one data feature for a performance of the model training, the effectiveness information being determined by the first apparatus during performing the model training by using the plurality of data samples.

In some example embodiments, further comprising: means for transmitting, a configuration indicating the at least one parameter comprising at least one of the following: a first indication used for enabling or disabling a function of transmitting the first report indicating the effectiveness information, or at least one attribute parameter for determining the effectiveness information.

In some example embodiments, the first report comprises at least one of the following: effectiveness values of the respective at least one data sample, or storage information of the first report.

In some example embodiments, the effectiveness information is specific to at least one of the following: an inference type, a training data source, a data feature for the model training, or a data feature set for the model training.

In some example embodiments, the first request used for triggering the model training comprises a second indication that indicates the first apparatus to provide the effectiveness information.

In some example embodiments, the first report comprises a third indication indicating one of the following: the effectiveness information requested by the second apparatus having been successfully determined, the effectiveness information requested by the second apparatus having been partially successfully determined, the effectiveness information requested by the second apparatus having not been determined, or not supporting to determine the effectiveness information requested by the second apparatus.

In some example embodiments, further comprising: means for configuring the second apparatus to enable the second apparatus to transmit the first request comprising second indication.

In some example embodiments, the first apparatus is a producer for model training and the second apparatus is a consumer for model training.

In some example embodiments, the second apparatus further comprises means for performing other operations in some example embodiments of the method 800 or the second device 120. In some example embodiments, the means comprises at least one processor; and at least one memory storing instructions that, when executed by the at least one processor, cause the performance of the second apparatus.

In some example embodiments, a third apparatus capable of performing any of the method 900 (for example, the first device 110 in FIG. 1A may comprise means for performing the respective operations of the method 900. The means may be implemented in any suitable form. For example, the means may be implemented in a circuitry or software module. The first apparatus may be implemented as or included in the first device 110 in FIG. 1A.

In some example embodiments, the first apparatus comprises means for receiving, from a second apparatus, a second request for information associated with a first plurality of data samples used for a model training, a first plurality of effectiveness values of the first plurality of data samples being higher than a second plurality of effectiveness values of a second plurality of data samples used for the model training, the effectiveness information indicating usefulness of at least one data sample or at least one data feature for a performance of the model training; means for determining, the information based at least in part on the second request; and means for transmitting, to the second apparatus, a second report indicating the information associated with the first plurality of data sample.

In some example embodiments, means for determining the information comprises: means for generating, based on the second request, a third request for the information; means for transmitting, the third request for the information to a third apparatus which is a producer for management data analytics (MDA); and means for receiving the information from the third apparatus.

In some example embodiments, the second request comprises at least one parameter used for determining the first plurality of data samples, the at least one parameter comprising at least one of the following: an effectiveness threshold, version information of a model, or a specific use case of one or more model.

In some example embodiments, means for determining the information comprises: means for determining the first plurality of data samples based on the at least one parameter, and means for determining the information based on context information of the first plurality of data samples.

In some example embodiments, the information comprises at least one of the following: a combination of data features corresponding to the first plurality of data samples, identity information of at least one network object corresponding to the first plurality of data samples, geographical location information of the at least one network object, network area information corresponding to the first plurality of data samples, or collection time information corresponding to the first plurality of data samples.

In some example embodiments, the first apparatus is a producer for model training and the second apparatus is a consumer for model training, the first apparatus is a producer for training data analytics and the second apparatus is a consumer for training data analytics, or the first apparatus is producer for management data analytics (MDA) and the second apparatus is a consumer for MDA.

In some example embodiments, the first apparatus further comprises means for performing other operations in some example embodiments of the method 900 or the first device 110. In some example embodiments, the means comprises at least one processor; and at least one memory storing instructions that, when executed by the at least one processor, cause the performance of the third apparatus.

In some example embodiments, a second apparatus capable of performing any of the method 1000 (for example, the second device 120 in FIG. 1A may comprise means for performing the respective operations of the method 1000. The means may be implemented in any suitable form. For example, the means may be implemented in a circuitry or software module. The fourth apparatus may be implemented as or included in the second device 120 in FIG. 1A.

In some example embodiments, the second apparatus comprises means for means for transmitting, to a first apparatus, a second request for information associated with a first plurality of data samples used for a model training, a first plurality of effectiveness values of the first plurality of data samples being higher than a second plurality of effectiveness values of a second plurality of data samples used for the model training, the effectiveness information indicating usefulness of at least one data sample or at least one data feature for a performance of the model training; and means for receiving, from the first apparatus, a second report indicating the information associated with the first plurality of data samples.

In some example embodiments, the second request comprises at least one parameter used for determining the first plurality of data samples, the at least one parameter comprising at least one of the following: an effectiveness threshold, version information of one or more model, or a specific use case of one or more model.

In some example embodiments, the information comprises at least one of the following: a combination of data features corresponding to the first plurality of data samples, identity information of at least one network object corresponding to the first plurality of data samples, geographical location information of the at least one network object, network area information corresponding to the first plurality of data samples, or collection time information corresponding to the first plurality of data samples.

In some example embodiments, the first apparatus is a producer for model training and the second apparatus is a consumer for model training, the first apparatus is a producer for training data analytics and the second apparatus is a consumer for training data analytics, or the first apparatus is producer for management data analytics (MDA) and the second apparatus is a consumer for MDA.

In some example embodiments, the fourth apparatus further comprises means for performing other operations in some example embodiments of the method 1000 or the second device 120. In some example embodiments, the means comprises at least one processor; and at least one memory storing instructions that, when executed by the at least one processor, cause the performance of the fourth apparatus.

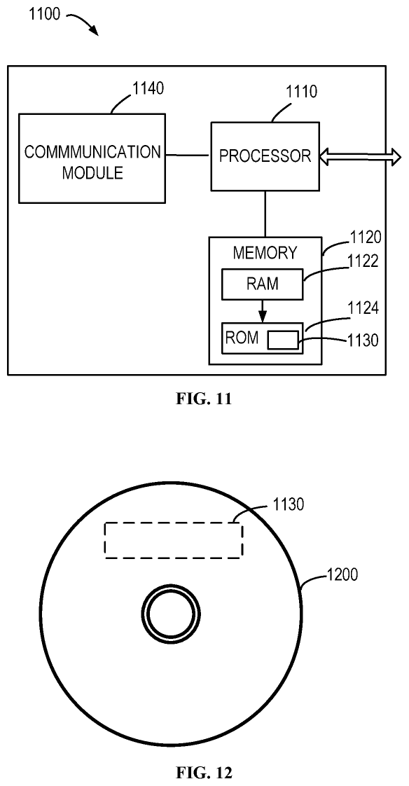

FIG. 11 is a simplified block diagram of a device 1100 that is suitable for implementing example embodiments of the present disclosure. The device 1100 may be provided to implement a communication device, for example, the first device 110 or the second device 120 as shown in FIG. 1A. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2A to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-57. (canceled)

58. A first device comprising:
at least one processor; and
at least one memory storing instructions that, when executed by the at least one processor, cause the first device at least to perform:
receiving, from a second device, a first request used for querying effectiveness information of a plurality of data samples used for a model training at the first device;
determining effectiveness information of at least one data sample of the plurality of data samples used for the model training, the effectiveness information indicating usefulness of at least one data sample or at least one data feature for a performance of the model training; and
transmitting, to the second device, a first report indicating the effectiveness information.

59. The first device of claim 58, wherein the first device is further caused to perform:
configuring, at least one parameter to the first device, the at least one parameter comprising at least one of the following:
a first indication used for enabling or disabling a function of transmitting the first report indicating the effectiveness information, or
at least one attribute parameter for determining the effectiveness information.

60. The first device of claim 59, wherein the first device is further caused to perform:
receiving, from a second device, a configuration indicating the at least one parameter.

61. The first device of claim 58, wherein the effectiveness information is specific to at least one of the following:
an inference type,
a training data source,
a data feature for the model training, or
a data feature set for the model training.

62. The first device of claim 58, wherein the first report comprises at least one of the following:
at least one respective effectiveness value of the at least one data sample, or storage information of the first report.

63. The first device of claim 58, wherein the model training at the first device is triggered by a receipt of the first request.

64. The first device of claim 58, wherein the first report comprises a third indication indicating one of the following:
the effectiveness information requested by the second device having been successfully determined;
the effectiveness information requested by the second device having been partially successfully determined;
the effectiveness information requested by the second device having not been determined; or
not supporting to determine the effectiveness information requested by the second device.

65. The first device of claim of claim 58, wherein the first device is a producer for model training and the second device is a consumer for model training.

66. A second device comprising:
at least one processor; and
at least one memory storing instructions that, when executed by the at least one processor, cause the second device at least to perform:
transmitting, to a first device, a first request used for querying effectiveness information of a plurality of data samples used for a model training at the first device; and
receiving, from the second device, a first report indicating effectiveness information of at least one data sample of a plurality of data samples used for the model training, the effectiveness information indicating usefulness of at least one data sample or at least one data feature for a performance of the model training, the effectiveness information being determined by the first device during performing the model training by using the plurality of data samples.

67. The second device of claim 66, wherein the second device is further caused to perform:
transmitting, a configuration indicating the at least one parameter comprising at least one of the following:
a first indication used for enabling or disabling a function of transmitting the first report indicating the effectiveness information, or
at least one attribute parameter for determining the effectiveness information.

68. The second device of claim 66, wherein the first report comprises at least one of the following:
effectiveness values of the respective at least one data sample, or
storage information of the first report.

69. The second device of claim 66, wherein the effectiveness information is specific to at least one of the following:
an inference type,
a training data source,
a data feature for the model training, or
a data feature set for the model training.

70. The second device of claim 66, wherein the model training at the first device is triggered by a receipt of the first request.

71. The second device of claim 66, wherein the first report comprises a third indication indicating one of the following:
the effectiveness information requested by the second device having been successfully determined,
the effectiveness information requested by the second device having been partially successfully determined,
the effectiveness information requested by the second device having not been determined, or
not supporting to determine the effectiveness information requested by the second device.

72. The second device of claim 70, wherein the second device is further caused to perform:
configuring the second device to enable the second device to transmit the first request comprising second indication.

73. The second device of claim of claim 66, wherein the first device is a producer for model training and the second device is a consumer for model training.

72. A first device comprising:
at least one processor; and
at least one memory storing instructions that, when executed by the at least one processor, cause the first device at least to perform:
receiving, from a second device, a second request for information associated with a first plurality of data samples used for a model training, a first plurality of effectiveness values of the first plurality of data samples being higher than a second plurality of effectiveness values of a second plurality of data samples used for the model training, the effectiveness value indicating a degree of usefulness of at least one data sample or at least one data feature for a performance of the model training;
determining the information based at least in part on the second request; and
transmitting, to the second device, a second report indicating the information associated with the first plurality of data samples.

73. The first device of claim 72, wherein determining the information comprises:
generating, based on the second request, a third request for the information;
transmitting, the third request for the information to a third device which is a producer for management data analytics (MDA); and
receiving the information from the third device.

74. The first device of claim 73, wherein the second request comprises at least one parameter used for determining the first plurality of data samples, the at least one parameter comprising at least one of the following:
an effectiveness threshold,
version information of a model, or
a specific use case of one or more model.

75. The first device of claim 74, wherein determining the information comprises:
determining the first plurality of data samples based on the at least one parameter, and
determining the information based on context information of the first plurality of data samples.
